(19) United States
(12) Patent Application Publication
(10) Pub. No.: US 2021/0240054 A1
(43) Pub. Date: Aug. 5, 2021

(54) JEWELRY PHOTOGRAPHY APPARATUS

(71) Applicant: HEIG LIMITED, Central (HK)

(72) Inventor: William Chu, Central (HK)

(21) Appl. No.: 16/780,952

(22) Filed: Feb. 4, 2020

(51) Int. Cl. G03B 15/00; G03B 17/56

(52) U.S. Cl. CPC G03B 15/00; G03B 17/561

(57) ABSTRACT

Disclosed is an apparatus for photography of an ornament using at least one photography device. The apparatus may include at least one viewing angle configuration and a sliding assembly. The at least one viewing angle configuration may be taperedly aligned to provide an angled view to the ornament. The sliding assembly may be slidingly and taperedly aligned along the at least one viewing angle configuration. The sliding assembly may be adapted to receive at least one photography device to taperedly align the at least one photography device along the at least one viewing angle configuration for photography of the ornament.

### FIELD OF THE DISCLOSURE

The present disclosure generally relates to a photography equipment, more particularly, to a jewelry photography apparatus created to capture photos and videos of small gemstones specifically semi-precious and precious gems, sapphires, rubies, emeralds, and diamonds.

### BACKGROUND OF THE DISCLOSURE

With the increase of digital media and online shopping trends, photography or videography has emerged as one of the most popular mediums to showcase the products. Among consumer products, jewelry is one of the hardest products to photograph because of the nature of its components, tiny details, and intricate designs. The precious stones, diamonds, metals and other elements that most fine jewelry are made up of have reflective qualities that can easily show unwanted reflections, shadows, and hard spots in photographs if the right tools are not used.

Positioning a jewelry correctly is essential for getting a professional-quality photograph. When customers look at photographs of a jewelry, they tend to judge the quality of the photographs more than the jewelry in the photo. Consequently, it is desirable and a requirement, especially among jewelry retailers, to take the best photographs possible. Taking photographs from the correct angles and perspectives using proper lighting is key to successful shots.

Conventionally, one of the most popular approaches is positioning a jewelry to a complementary stand and taking shots. For example, to take shots of a finger ring, a pyramid ring stand is used, which holds the ring at a 45-degree angle. A drawback of such complementary stand is that it remains at least partially visible in the photograph irrespective of its color being white or transparent.

Accordingly, there exists a need for jewelry photographs without reflections, shadows, hard spots, and visible complementary stands to aid consumers in making better decisions while shopping.

### SUMMARY OF THE DISCLOSURE

In view of the foregoing disadvantages inherent in the conventional approach, the general purpose of the present disclosure is to provide an apparatus for photography of jewelry to include all advantages of the conventional approach, and to provide solutions to overcome the drawbacks inherent in the conventional approach.

An object of the present disclosure is to provide jewelry photographs without reflections, shadows, and hard spots or such complementary stands visible to the consumers to help them make better decisions while shopping.

In one aspect of the present disclosure, an apparatus for photography of small, loose gemstones and diamonds using at least one photography device is provided. The apparatus may include at least one viewing angle configuration and a sliding assembly. The at least one viewing angle configuration may be taperedly aligned to provide an angled view to the ornament. The sliding assembly can be adjusted by sliding the assembly to make it taperedly aligned with the at least one viewing angle configuration. The sliding assembly may be adapted to receive at least one photography device to taperedly align the at least one photography device along the at least one viewing angle configuration for photography of the ornament.

In another aspect of the present disclosure, an apparatus for photography of an ornament using at least one photography device is disclosed. The apparatus may include a housing assembly having an enclosing space. The apparatus further includes at least one window configuration, a channel configuration, at least one platform, and a sliding assembly coupled to the housing assembly. The at least one window configuration may be taperedly aligned to define a first viewing angle configuration of the ornament within the enclosing space of the housing member. Further, the channel configuration may include a pair of channel members that may be configured side by side of the at least one window configuration. Furthermore, the at least one platform may be disposed within the enclosing space to receive the ornament thereon. The at least one platform may be fully rotatable, and movable in lateral and vertical directions. Moreover, the sliding assembly may be slidingly and taperedly attached to the channel configuration of the housing assembly along the at least one window configuration. The sliding assembly may be taperedly slidable in a vertical direction along the channel configuration. The sliding assembly may be configured to receive at least one photography device to taperedly align the at least one photography device along the at least one window configuration for photography of the ornament placed on the at least one platform within the enclosing space of the housing assembly.

In another aspect of the present disclosure, the housing assembly may include a base member, a top member, opposite front and back members, and opposite side members coupled to configure the housing assembly. In one arrangement, the base member, the top member, the opposite front and back members, and the opposite side members collectively combined to define the enclosing space. Further, the opposite front and back members may be extending side by side from the base member. In one example form, the front member may be smaller than the height of the back member. Further, the opposite side members may be extending side by side from the base member between the opposite front and back members. The at least a portion of each of the opposite side members may be tapered to define a first height and a second height of each of the opposite side members. In one example form, the first height may be smaller than the second height. Furthermore, the front member, which is smaller in height, may be disposed between the opposite side members along the first height thereof, and, the back member, which is bigger in height, is disposed between the opposite side members along the second height thereof. Moreover, the top member may be disposed along edges of the opposite front and back members and the opposite side members to be taperedly aligned with respect to the base member.

In another aspect of the present disclosure, the apparatus may further include a cover member adapted to be disposed over the top member to cover the apparatus from a top side thereof.

In another aspect of the present disclosure, the apparatus may further include a refractor window plate for covering an opening of the at least one window configuration that is provided to access the internal space. In one embodiment, the refractor window plate may include an optical lens arrangement, and at least one window member. The optical lens arrangement may be adapted to provide enhanced viewing of the ornament for photography in the enclosing space via the at least one photography device along the first viewing angle configuration. Further, the at least one window member may be adapted to provide a normal viewing of the ornament in the enclosing space via the at least one photography device along the first viewing angle configuration.

In another aspect of the present disclosure, the at least one platform may be configured to the base member to rotatable along degrees to adjust orientation of the ornament with respect to the at least one window configuration for photography from the at least one photography device. Further, the at least one platform may also be configured to the base member to be movable in laterally forward and backward directions to adjust distance of the ornament with respect to the at least one window configuration for photography from the at least one photography device. The at least one platform may be configured to the base member to be movable in vertically up and down directions to adjust height of the ornament with respect to the at least one window configuration for photography from the at least one photography device.

In another aspect of the present disclosure, the sliding assembly may include a pair of slidable members, a holding member, and a pair of stud members. Each of the pair of slidable members may include opposite end portions, and a grooved portion extending between the opposite end portions. The pair of slidable member may be coupled to the pair of channel members of the channel configuration. Further, the holding member may be extending horizontally between the pair of slidable members to hold the at least one photography device. Furthermore, each of the pair of stud members may be received within the respective grooved portions of the pair of slidable member, and removably coupled to the respective channel members of the pair of channel members to enable the pair of slidable member to slidably move along the pair of stud member.

In another aspect of the present disclosure, the holding member may include a grooved member and a stud member. The grooved member may be extending along the holding member, and the stud member may be slidably coupled along the grooved member of the holding member.

In another aspect of the present disclosure, the at least one of the slidable member of the pair of slidable member may include a measuring marking to measure a position of the sliding assembly.

In another aspect of the present disclosure, the at least one of the stud members of the pair of stud member may include a locking rim coupled to the stud member to lock and unlock the stud member to enable restricting and sliding of the sliding assembly along the channel configuration.

In another aspect of the present disclosure, the apparatus may include a height adjustable knob configured to the housing member and engaged with at least one platform to adjust the at least one platform in the vertical direction.

In another aspect of the present disclosure, the apparatus may include a depth adjustable arrangement configured to the housing member. The depth adjustable arrangement may include a depth adjusting knob and a depth adjusting groove. The depth adjusting groove may be disposed along the depth adjusting groove and engaged with at least one platform to adjust the depth of the at least one platform in the lateral direction.

In another aspect of the present disclosure, the apparatus may include a plurality of lighting buttons and a plurality of colored lights. The plurality of colored lights may be operatively configured with the plurality of lighting buttons. Further, the plurality of lighting buttons may be disposed along the housing member to enable lightening of the housing member, when at least one lighting button of the plurality of lighting buttons is pressed.

In another aspect of the present disclosure, the apparatus may include a powering arrangement to power the apparatus. The powering arrangement may include a powering point and a powering button.

In another aspect of the present disclosure, the apparatus may include a vacuum creating arrangement having a vacuum creating hole configured along the housing member. The vacuum creating hole may be adapted to be configured with a suction device to create a vacuum within the housing member to enable the ornament to be vertically oriented within the housing member.

In another aspect of the present disclosure, the apparatus may include a rear window configuration configured on a rear portion of the housing member to provide a second viewing angle configuration to the ornament within the enclosing space for photography from the at least one photography device.

In another aspect of the present disclosure, the apparatus may include a rear sliding assembly and a rear channel configuration along the rear portion of the housing member. The rear sliding assembly may be slidingly attached to the rear channel configuration along the rear window configuration to be slidable in a vertical direction along the rear channel configuration.

In another aspect of the present disclosure, the apparatus may include a rear refractor window plate to cover the rear window configuration. The rear refractor window plate may include a rear optical lens arrangement and at least one window member. The rear optical lens arrangement adapted to provide enhanced viewing of the ornament for photography in the enclosing space via the at least one photography device along the second viewing angle configuration. Further, the at least one window member may be adapted to provide normal viewing of the ornament in the enclosing space via the at least one photography device along the second viewing angle configuration.

In another aspect of the present disclosure, a system for photography of an ornament using at least one photography device is provided. The system may include the apparatus and a photography module incorporated in the at least one photography device. The apparatus includes a viewing angle configuration taperedly aligned to provide an angled view to the ornament; and a first sliding assembly slidingly and taperedly aligned along the viewing angle configuration. Further, the photography module may be incorporated in the at least one photography device, wherein the photography module is wirelessly coupled to the apparatus to capture photographs of the ornament. Furthermore, the first sliding assembly may be adapted to receive at least one photography device to taperedly align the at least one photography device along the viewing angle configuration for photography of the ornament via the photography module.

In another aspect of the present disclosure, an apparatus for photography of an ornament using at least one photography device is provides. The apparatus includes at least one viewing angle configuration and a sliding assembly. The at least one viewing angle configuration may be aligned to provide at least one view to the ornament. Further, the sliding assembly may be slidingly aligned along the at least one viewing angle configuration. The sliding assembly may be adapted to receive at least one photography device to align the at least one photography device along the at least one viewing angle configuration for photography of the ornament.

This together with the other aspects of the present disclosure, along with the various features of novelty that characterizes the present disclosure, is pointed out with particularity in the claims annexed hereto and forms a part of the present disclosure. For a better understanding of the present disclosure, its operating advantages, and the specified object attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 illustrates a left-hand perspective view of a jewelry apparatus, in accordance with an embodiment of the present disclosure;

FIG. 2 illustrates a right-hand perspective view of a jewelry apparatus, in accordance with an embodiment of the present disclosure;

FIG. 3 illustrates an exploded view of the jewelry apparatus of FIG. 1, in accordance with an embodiment of the present disclosure;

FIGS. 4A and 4B illustrate side views a jewelry apparatus, in accordance with an embodiment of the present disclosure;

FIGS. 5A and 5B illustrate front and rear views of the jewelry apparatus, in accordance with an embodiment of the present disclosure;

FIGS. 6A and 6B illustrate top and bottom views a jewelry apparatus, in accordance with an embodiment of the present disclosure;

FIGS. 7A and 7B illustrate a jewelry apparatus including a sliding assembly at various positions, in accordance with an embodiment of the present disclosure;

FIGS. 8A and 8B illustrate rear views a jewelry apparatus, in accordance with another embodiment of the present disclosure;

FIG. 9 illustrates line diagram of various angle views, in accordance with another embodiment of the present disclosure; and

FIG. 10 illustrates a system having a perspective view of a jewelry apparatus including a photography device, in accordance with another embodiment of the present disclosure.

Like reference numerals refer to like parts throughout the description of several views of the drawings.

### DETAILED DESCRIPTION OF THE DISCLOSURE

For a thorough understanding of the present disclosure, reference is to be made to the following detailed description, including the appended claims, in connection with the above-described drawings. Although the present disclosure is described in connection with exemplary embodiments, the present disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The terms, “a” and “an” herein do not denote a limitation of quantity, but rather denote the presence of at least one of the referenced items.

The present disclosure provides an apparatus for photography of an ornament using at least one photography device, in one embodiment. The apparatus may include at least one viewing angle configuration and a sliding assembly. The at least one viewing angle configuration may be taperedly aligned to provide an angled view to the ornament. The sliding assembly may be slidingly and taperedly aligned along the at least one viewing angle configuration. The sliding assembly may be adapted to receive at least one photography device to taperedly align the at least one photography device along the at least one viewing angle configuration for photography of the ornament.

The present disclosure provides an apparatus for photography of an ornament using at least one photography device, in another embodiment. The apparatus may include a housing assembly having an enclosing space. The apparatus further includes at least one window configuration, a channel configuration, at least one platform, and a sliding assembly coupled to the housing assembly. The at least one window configuration may be taperedly aligned to define a first viewing angle configuration of the ornament within the enclosing space of the housing member. Further, the channel configuration may include a pair of channel members that may be configured side by side of the at least one window configuration. Furthermore, the at least one platform may be disposed within the enclosing space to receive the ornament thereon. The at least one platform may be fully rotatable, and movable in lateral and vertical directions. Moreover, the sliding assembly may be slidingly and taperedly attached to the channel configuration of the housing assembly along the at least one window configuration. The sliding assembly may be taperedly slidable in a vertical direction along the channel configuration. The sliding assembly may be configured to receive at least one photography device to taperedly align the at least one photography device along the at least one window configuration for photography of the ornament placed on the at least one platform within the enclosing space of the housing assembly.

The present disclosure provides a system for photography of an ornament using at least one photography device. The system may include the apparatus and a photography module incorporated in the at least one photography device. The apparatus includes a viewing angle configuration taperedly aligned to provide an angled view to the ornament; and a first sliding assembly slidingly and taperedly aligned along the viewing angle configuration. Further, the photography module may be incorporated in the at least one photography device, wherein the photography module is wirelessly coupled to the apparatus to capture photograph of the ornament. Furthermore, the first sliding assembly may be adapted to receive at least one photography device to taperedly align the at least one photography device along the viewing angle configuration for photography of the ornament via the photography module.

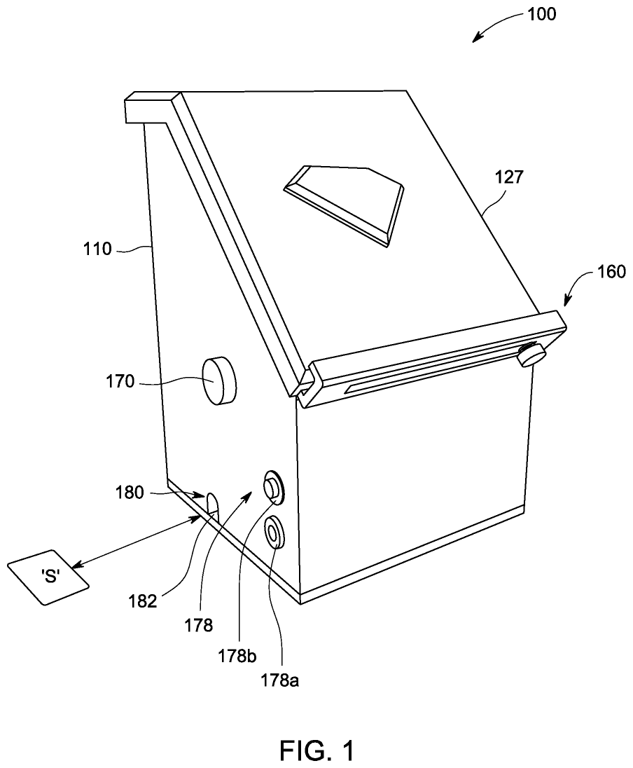

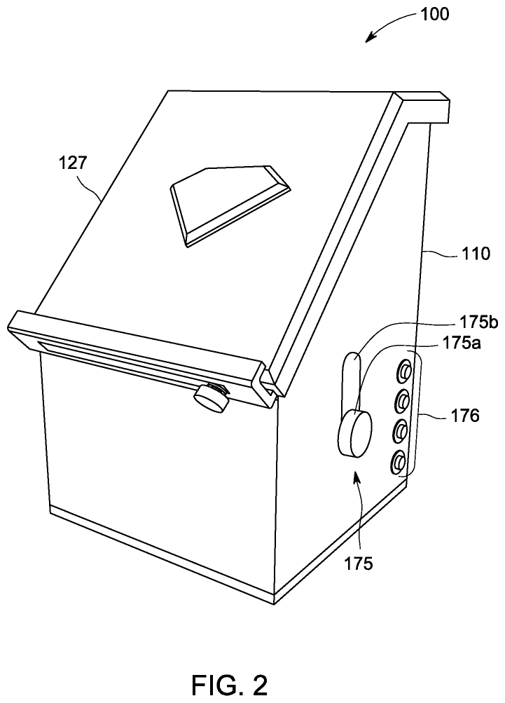

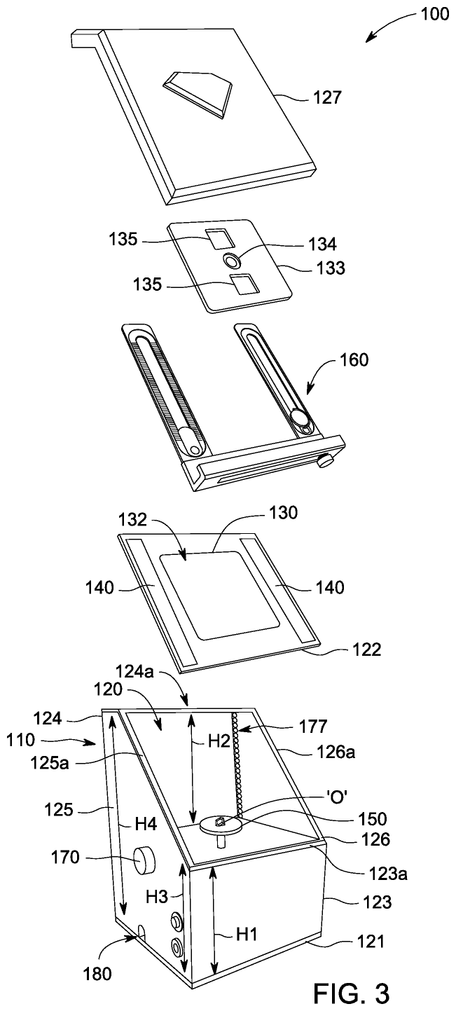

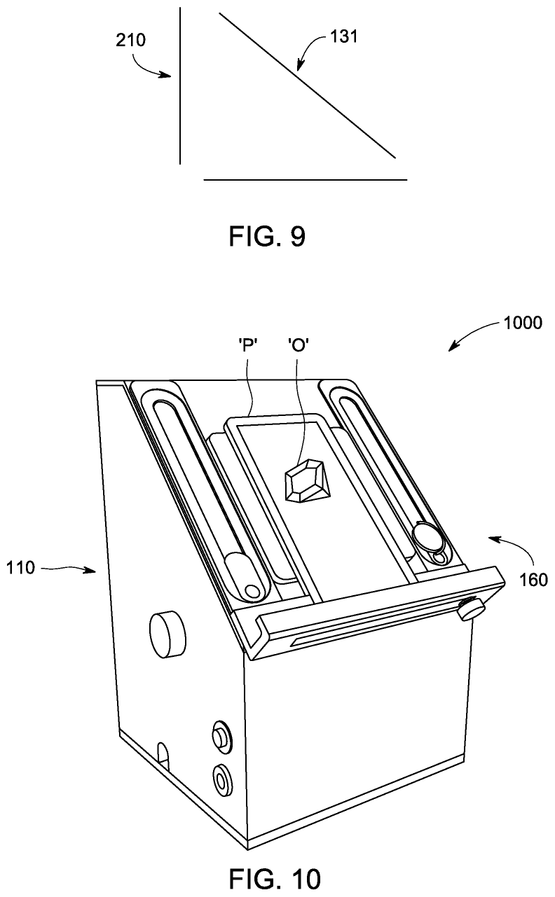

Referring now to FIGS. 1 to 3, which illustrate various views of a jewelry apparatus 100, in accordance with an embodiment of the present disclosure. For example, FIG. 1 illustrates a left-hand perspective view of the jewelry apparatus 100; FIG. 2 illustrates a right-hand perspective view of the jewelry apparatus 100, and FIG. 3 illustrates an exploded view of the jewelry apparatus 100 as shown in FIGS. 1 and 2, in accordance with an embodiment of the present disclosure. The jewelry apparatus 100, which may have a box like configuration, for photography of an ornament ‘O’ using at least one photography device ‘P’ (as seen in FIG. 9) is provided. and may be made from any suitable or desired materials, including, acrylic materials, steel materials (including stainless steel), aluminum materials, other metal alloy materials, polymeric materials, combinations of various materials, and the like.

The apparatus 100, as shown, for example in FIGS. 1 to 3, includes a housing assembly 110 having an enclosing space 120. The apparatus further includes at least one window configuration 130, a channel configuration 140, at least one platform 150, and a sliding assembly 160 coupled to the housing assembly 110.

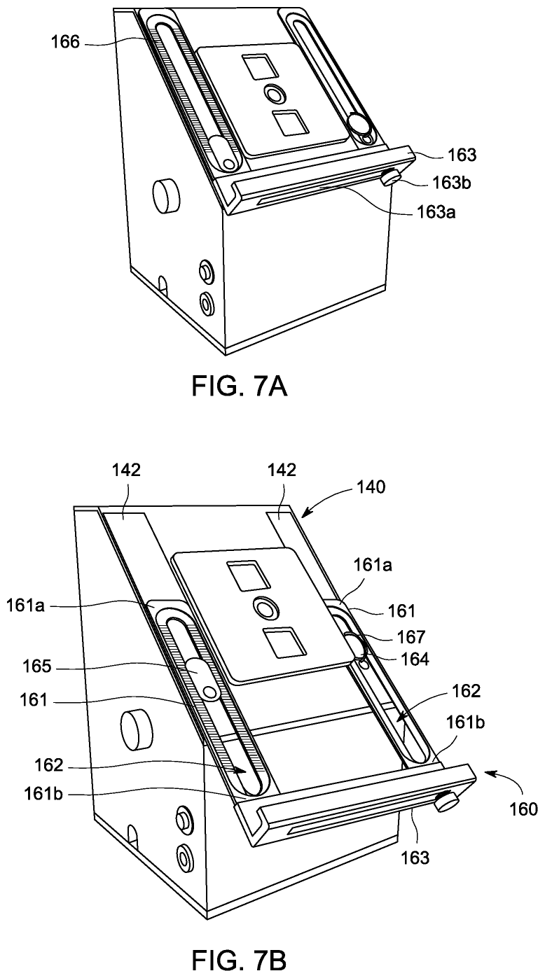

In one embodiment, as shown in FIGS. 1-3, mainly in FIG. 3, the at least one window configuration 130 may be taperedly aligned to define a first viewing angle configuration 131 (as seen in FIG. 9) of the ornament ‘O’ within the enclosing space 120 of the housing member 110. Further, the channel configuration 140 may include a pair of channel members 142 that may be configured side by side of the at least one window configuration 130. Furthermore, the at least one platform 150 may be disposed within the enclosing space 120 to receive the ornament ‘O’ thereon. The at least one platform 150 may be fully rotatable, and movable in lateral and vertical directions. Moreover, the sliding assembly 160 may be slidingly and taperedly attached to the channel configuration 140 of the housing assembly 110 along the at least one window configuration 130. The sliding assembly 160 may be taperedly slidable in a vertical direction along the channel configuration 140, and will be explained herein in conjunction with FIGS. 7A and 7B. The sliding assembly 160 may be configured to receive at least one photography device ‘P’ to taperedly align the at least one photography device ‘P’ along the at least one window configuration 130 for photography of the ornament ‘O’ placed on the at least one platform 150 within the enclosing space 120 of the housing assembly 110.

In one embodiment, as shown in FIG. 3, the housing member 110 may be one-piece or multi-piece structure. However, in order to have better understanding of overall structure to the person ordinary skilled in the art, the housing member 110 will be explained by the way of several parts, which may be a multi-part and combined to obtain the housing member 110; or the housing structure 110 may be a one-piece structure molded together. As shown in exploded view of the housing member in FIG. 3, the housing assembly 120 may include a base member 121, a top member 122, opposite front 123 and back 124 members, and opposite side members 125, 126 coupled to configure the housing assembly 110. In one arrangement, the base member 121, the top member 122, the opposite front and back members 123, 124 and the opposite side members 125, 126 collectively combined to define the enclosing space 120. As shown in the example FIG. 3, the opposite front 123 and back 124 members may be extending side by side from the base member 121. In one example form, the front member 123 may be smaller in height ‘H1’ than the height of the back member 124. Further, the opposite side members 125, 126 may be extending side by side from the base member 121 between the opposite front and back members 123, 124. The at least a portion of each of the opposite side members 125, 126 may be tapered to define a first height and a second height ‘H4’ of each of the opposite side members 125, 126. In one example form, the first height ‘H3’ may be smaller than the second height ‘H4’. Furthermore, the front member 123, which is smaller in height (H1), may be disposed between the opposite side members 125, 126 along the first height thereof, and, the back member 124, which is bigger in height (H2), is disposed between the opposite side members 125, 126 along the second height thereof. Moreover, the top member 122 may be disposed along edges 123a, 124a, 125a and 126a of the opposite front and back members 125, 126 and the opposite side members 123, 124 to be taperedly aligned with respect to the base member 121. The base member 121 may include holes 121a to incorporate screws to assemble the housing member 110 on any surface.

As seen in FIG. 3, the top member 122 may include the at least one window configuration 130 configured thereon. In FIG. 3, one window configuration, such as the window configuration 130 is shown to be configured along the top member 122 of the housing member 120. In one embodiment, the window configuration 130 may include an opening 132 to access the enclosing space 120 of the housing structure 110 to place or remove the ornament ‘O’ on the platform structure 150 to photograph the ornament ‘O’.

The housing member 110, as shown and described in FIGS. 1-3, is only for exemplary purpose and better understanding of an embodiment of the present disclosure and shall not be considered to be limiting to only explained housing structure 110. The housing member 110 may include any other shape or design as far as, it provides at least one tapered orientation to the photography device ‘P’ to photograph the ornament ‘O’

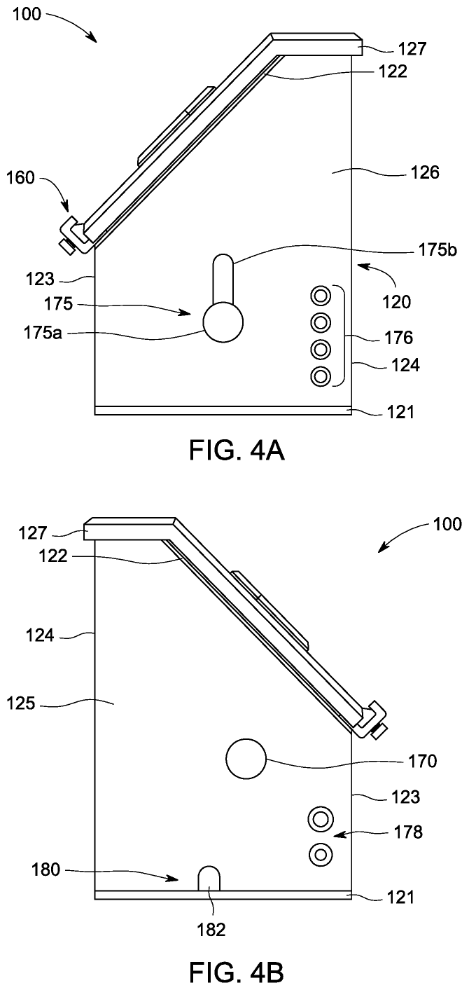

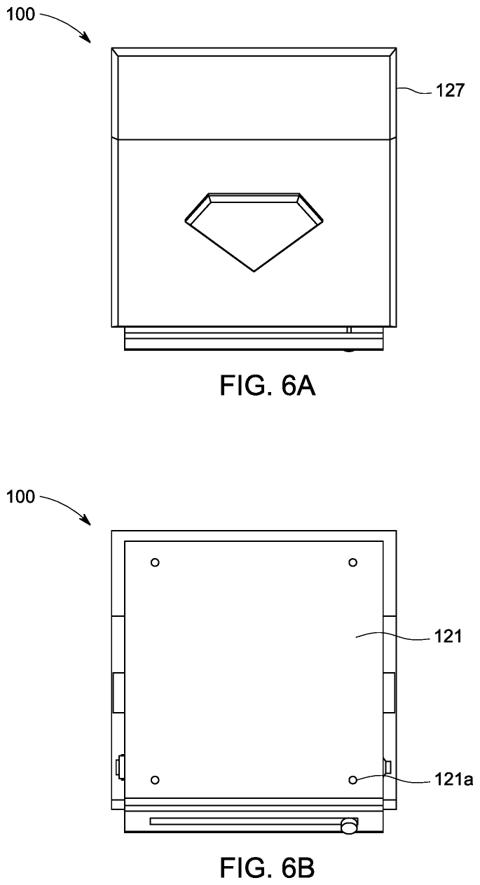

In one embodiment, as shown in various figures, such as FIGS. 1-3, 4A-4B, and FIG. 6A, the apparatus 100 may further include a cover member 127 adapted to be disposed over the top member 122 to cover the apparatus 100 from a top side thereof.

In one embodiment, the apparatus 100 may further include a refractor window plate 133 for covering the opening 132 of the window configuration 130 that is provided to access the internal space 120. In one embodiment, the refractor window plate 133 may include an optical lens arrangement 134, and at least one window member 135. The optical lens arrangement 134 may be adapted to provide enhanced viewing and photography of the ornament ‘O’ in the enclosing space 120 via the photography device ‘P’ along the first viewing angle configuration 131, as seen in FIG. 9. Further, the at least one window member 135 may be adapted to provide a normal viewing of the ornament ‘O’ in the enclosing space 120 via the at least one photography device ‘P’ along the first viewing angle configuration 131. In one embodiment, the first viewing angle configuration 131 may be 45 degrees, however, without departing from the scope of the present disclosure, the first viewing angle configuration 131 may be any angle varying greater than 0 degrees and less than 90 degrees.

In one embodiment, as shown in FIG. 3, the at least one platform 150 may be configured to the base member 121 to be rotatable along 360 degrees to adjust orientation of the ornament ‘O’ with respect to the at least one window configuration 130 for photography from the at least one photography device ‘P’. A suitable motor (not shown) may be incorporated to the housing member 110 for enabling rotation of the at least one platform 150. Further, the at least one platform 150 may also be configured to the base member 121 to be movable in laterally forward and backward directions to adjust distance of the ornament ‘O’ with respect to the at least one window configuration 130 for photography from the at least one photography device ‘P’. The platform 150 may be configured to the base member 121 to be movable in vertically up and down directions to adjust height of the ornament ‘O’ with respect to the at least one window configuration 150 for photography from the at least one photography device ‘P’.

In various embodiments, to adjust height, depth or distance, of the platform 150 as described above, the apparatus 100, for example, as shown in various figures, such as FIGS. 1-3, 4B and 5A-5B, may include a height adjustable knob 170 configured to the housing member 150 and engaged with at least one platform 150 to adjust the at least one platform 150 in the vertical direction.

Further, the apparatus 100, in such embodiment, may also include a depth adjustable arrangement 175 configured to the housing member 110. The depth adjustable arrangement 175 may include a depth adjusting knob 175a and a depth adjusting groove 175b. The depth adjusting groove 175b may be disposed along the depth adjusting groove 175b and engaged with at least one platform 150 to adjust the depth of the at least one platform 150 in the lateral direction.

In one embodiment, the apparatus 100 may include a plurality of lighting buttons 176 and a plurality of colored lights 177 (as seen in FIG. 3). The plurality of colored lights 177 may be operatively configured with the plurality of lighting buttons 176. Further, the plurality of lighting buttons 176 may be disposed along the housing member 110 to enable lightening of the housing member 110, when at least one lighting button 176 of the plurality of lighting buttons 176 is pressed.

In one embodiment, the apparatus 100 may include a powering arrangement 178 to power the apparatus 100. The powering arrangement 178 may include a powering point 178a and a powering button 178b. In other embodiment, the apparatus 100 may include battery to power the apparatus.

Referring to FIG. 3 and FIGS. 7A and 7B, in one embodiment, the sliding assembly 160 will be described herein in accordance with an exemplary embodiment of the present disclosure. The sliding assembly 160 may be disposed on the channel configuration 140 via a suitable attachment. As shown, the sliding assembly 160 may include a pair of slidable members 161, a holding member 163, and a pair of stud members 164, 165. Each of the pair of slidable members 161 may include opposite end portions 161a, 161b, and a grooved portion 162 extending between the opposite end portions 161a, 161b. The pair of slidable member 161 may be coupled to the pair of channel members 142 of the channel configuration 140. Further, the holding member 163 may be extending horizontally between the pair of slidable members 161 to hold the at least one photography device ‘P’. Furthermore, each of the pair of stud members 164, 165 may be received within the respective grooved portions 162 of the pair of slidable member 161, and removably coupled to the respective channel members 142 of the pair of channel members 140 to enable the pair of slidable member 161 to slidably move along the pair of stud member 164.

Further, as shown in example FIGS. 7A and 7B, in one embodiment, the holding member 163 may include a grooved member 163a and a stud member 163b. The grooved member 163a may be extending along the holding member 163, and the stud member 163b may be slidably coupled along the grooved member 163a of the holding member 163. The holding member 163 may receive the photography device ‘P’ thereon. The grooved member 163a may be provided to insert a charging wire to charge the photography device ‘P’. Further, the stud member 163b may be slidably adjustable in the grooved member 163a to keep in place the photography device ‘P’ along the holding member 163.

Further, as shown in example FIGS. 7A and 7B, in one embodiment, the at least one of the slidable member 161 of the pair of slidable member 161 may include a measuring marking 166 to measure a position of the sliding assembly 140.

Furthermore, in one embodiment, as shown in example FIGS. 7A and 7B, the at least one of the stud member 164 of the pair of stud member may include a locking rim 167 coupled to the stud member 164 to lock and unlock the stud member 164 to enable restricting and sliding of the sliding assembly 140 along the channel configuration 140.

The sliding member 160, as described above, is an exemplary form and the present disclosure shall not be considered restrictive to such sliding member. The present disclosure extent to include any addition or deletion of components in the sliding member 160.

In one another embodiment, the apparatus 100, as shown in FIGS. 1, 3 and 4A-4B, may include a vacuum creating arrangement 180 having a vacuum creating hole 182 configured along the housing member 110. The vacuum creating hole 182 may be adapted to be configured with a suction device ‘S’ to create a vacuum within the housing member 110 to enable the ornament ‘O’ to be vertically oriented within the housing member 110.

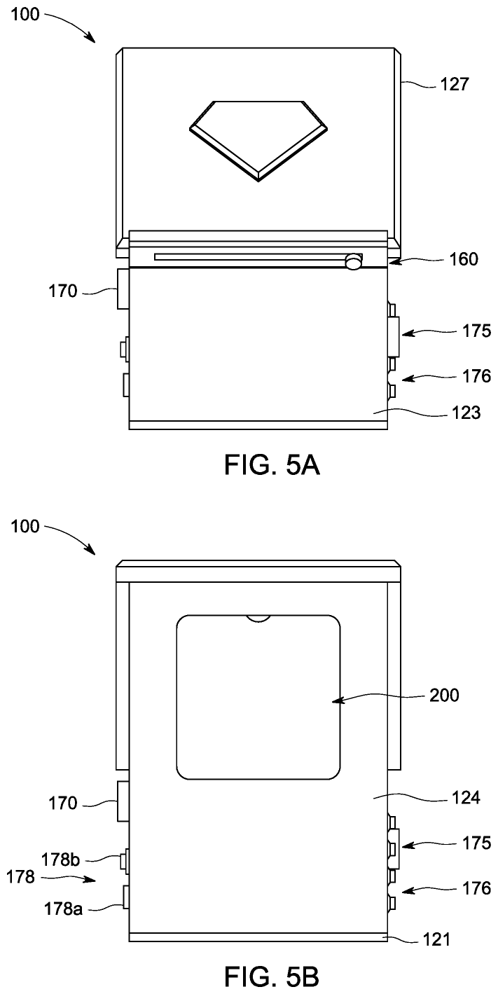

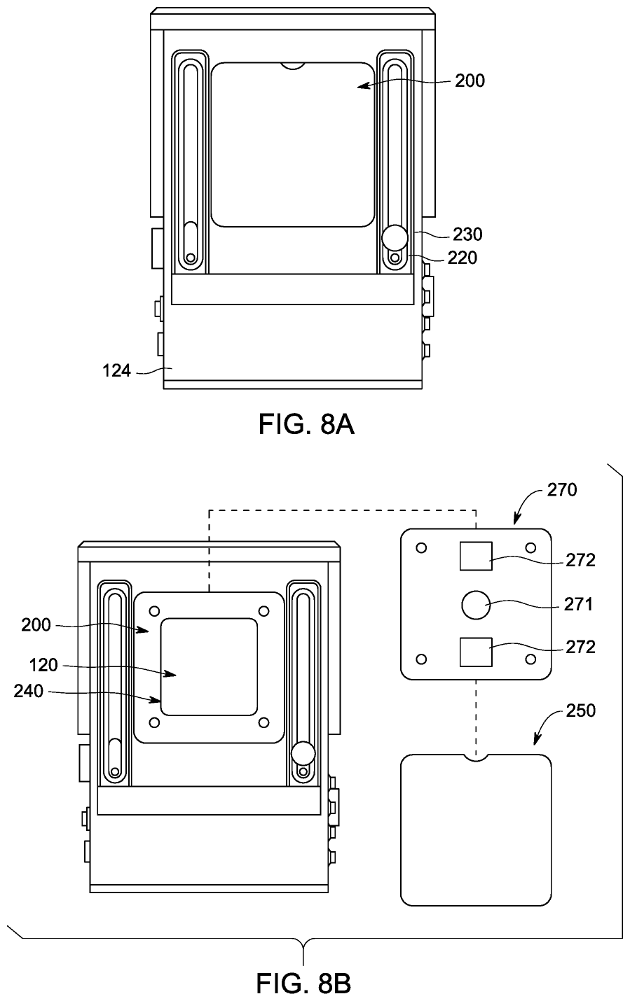

In one another embodiment, the apparatus 100, as shown in FIGS. 5B, and 8A-8B, the apparatus 100 may include a rear window configuration 200 configured on a rear portion of the housing member 110 to provide a second viewing angle configuration 210 to the ornament ‘O’ within the enclosing space 120 for photography from the at least one photography device ‘P’. The rear window configuration 200 may include rear window opening 240 which may be covered via a rear window covering plate 250.

In one embodiment, the apparatus 100, as shown in FIG. 8A, may include a rear sliding assembly 220 and a rear channel configuration 230 along the rear portion of the housing member 110. The rear sliding assembly 220 may be slidingly attached to the rear channel configuration 230 along the rear window configuration 200 to be slidable in a vertical direction along the rear channel configuration 230. In one embodiment, the second viewing angle configuration 210 may be in the vertical direction, for example, 90 degrees.

In one embodiment, as seen in FIG. 9, the first viewing angle configuration 131 the second viewing angle configuration 210 may be incorporated in a same apparatus, such as apparatus 100. However, without departing from the scope of the present disclosure, the first viewing angle configuration 131 and the second viewing angle configuration 210 may be incorporated two different apparatus, such as apparatus 100, depending upon the requirement at user's end.

The rear sliding assembly 220 and the rear channel configuration 230 may be similar to the sliding assembly 160 and the channel configuration 140 and excluded herein for further explanation for the sake of brevity.

In one embodiment, the apparatus 100 may include a rear refractor window plate 270 to cover the rear window configuration 230. The rear refractor window plate 270 may include a rear optical lens arrangement 271 and at least one window member 272. The rear optical lens arrangement 271 adapted to provide enhanced viewing of the ornament ‘O’ for photography in the enclosing space 120 via the at least one photography device ‘P’ along the second viewing angle configuration 210, Further, the at least one window member 242 may be adapted to provide normal viewing of the ornament ‘O’ in the enclosing space 120 via the at least one photography device ‘P’ along the second viewing angle configuration 210.

In one embodiment, a system 1000 for photography of an ornament ‘O’ using at least one photography device ‘I’′, is shown in FIG. 10. The system 1000 may include the apparatus 100 and a photography module incorporated in the at least one photography device ‘P’. The photography module may be an “App” installed on the photography device ‘P’, which may be a phone, tables and so forth. The photography module or the phone may be wirelessly coupled, for example via a Bluetooth, to the apparatus 100 to capture photograph of the ornament ‘o’.

In operation, as seen in FIG. 10 that illustrates a perspective view the jewelry apparatus 100 including the photography device ‘P’, such as the phone, to take photos or videos of the ornament ‘O’ will be explained. For taking a photo or a video of the ornament ‘O’ placed on the platform member 150, a photographer may place the phone on the holding member 163 of the sliding assembly 160 and adjust thereto to position the phone at desired location. Further, the photographer may also slide the sliding assembly 160 at tapered orientation along the channel configuration 140 to adjust the phone at a desired location along the at least one window configuration 130 to take photographs of the ornament ‘O’. The apparatus in present disclosure is advantageous for jewelry photographs to produce photo or video without reflections, shadows and hard spots or without the requirement of complementary stands.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. An apparatus for photography of an ornament using at least one photography device, the apparatus comprising:
at least one viewing angle configuration taperedly aligned to provide an angled view to the ornament; and
a sliding assembly slidingly and taperedly aligned along the at least one viewing angle configuration,
wherein the sliding assembly is adapted to receive at least one photography device to taperedly align the at least one photography device along the at least one viewing angle configuration for photography of the ornament.

2. The apparatus as claimed in claim 1, wherein the sliding assembly comprises:
a pair of slidable members, each having opposite end portions, and a grooved portion extending between the opposite end portions, the pair of slidable member coupled to the pair of channel members of the channel configuration;
a holding member extending horizontally between the pair of slidable members to hold the at least one photography device; and
a pair of stud members each received within the respective grooved portions of the pair of slidable member, and removably coupled to the respective channel members of the pair of channel members to enable the pair of slidable member to slidably move along the pair of stud member.

3. The apparatus as claimed in claim 2, wherein the holding member comprises:
a grooved member extending along the holding member, and
a stud member slidably coupled along the grooved member of the holding member.

4. The apparatus as claimed in claim 2, wherein at least one of the slidable member of the pair of slidable member comprises a measuring marking to measure a position of the sliding assembly.

5. The apparatus as claimed in claim 2, wherein at least one of the stud member of the pair of stud member comprises a locking rim coupled to the stud member to lock and unlock the stud member to enable restricting and sliding of the sliding assembly along the channel configuration.

6. An apparatus for photography of an ornament using at least one photography device, the apparatus comprising:
a housing assembly having an enclosing space;
at least one window configuration taperedly aligned to define a first viewing angle configuration of the ornament within the enclosing space;
a channel configuration having a pair of channel members configured side by side of the at least one window configuration;
at least one platform disposed within the enclosing space to receive the ornament, wherein the at least one platform is fully rotatable, and movable in lateral and vertical directions; and
a sliding assembly slidingly and taperedly attached to the channel configuration of the housing assembly along the at least one window configuration, the sliding assembly taperedly slidable in a vertical direction along the channel configuration,
wherein the sliding assembly is configured to receive at least one photography device to taperedly align the at least one photography device along the at least one window configuration for photography of the ornament placed on the at least one platform within the enclosing space of the housing assembly.

7. The apparatus as claimed in claim 6, wherein the housing assembly comprises:
a base member,
a top member,
opposite front and back members extending side by side from the base member, wherein the front member is smaller in height than the back member, and
opposite side members extending side by side from the base member between the opposite front and back members, wherein at least a portion of each of the opposite side members are tapered to define a first height and a second height of each of the opposite side members, wherein the first height is smaller than the second height,
wherein the front member, which is smaller in height, is disposed between the opposite side members along the first height thereof, and, wherein the back member, which is bigger in height, is disposed between the opposite side members along the second height thereof, and
wherein the top member is disposed along edges of the opposite front and back members and the opposite side members to be taperedly aligned with respect to the base member, and,
wherein the base member, the top member, the opposite front and back members and the opposite side members collectively combined to define the enclosing space.

8. The apparatus as claimed in claim 7 further comprising a cover member adapted to be disposed over the top member to cover the apparatus from a top side thereof.

9. The apparatus as claimed in claim 6, further comprising a refractor window plate for covering an opening of the at least one window configuration to access the internal space.

10. The apparatus as claimed in claim 9, wherein the refractor window plate comprises:
an optical lens arrangement to provide enhanced viewing of the ornament for photography in the enclosing space via the at least one photography device along the first viewing angle configuration; and
at least one window member to provide normal viewing of the ornament in the enclosing space via the at least one photography device along the first viewing angle configuration.

11. The apparatus as claimed in claim 6, wherein the at least one platform is configured to the base member to:
rotatable along 360 degrees to adjust orientation of the ornament with respect to the at least one window configuration for photography from the at least one photography device, and
movable in laterally forward and backward directions to adjust distance of the ornament with respect to the at least one window configuration for photography from the at least one photography device, and
movable in vertically up and down directions to adjust height of the ornament with respect to the at least one window configuration for photography from the at least one photography device.

12. The apparatus as claimed in claim 6, wherein the sliding assembly comprises:
a pair of slidable members, each having opposite end portions, and a grooved portion extending between the opposite end portions, the pair of slidable member coupled to the pair of channel members of the channel configuration;
a holding member extending horizontally between the pair of slidable members to hold the at least one photography device; and
a pair of stud members each received within the respective grooved portions of the pair of slidable member, and removably coupled to the respective channel members of the pair of channel members to enable the pair of slidable member to slidably move along the pair of stud member.

13. The apparatus as claimed in claim 12, wherein the holding member comprises:
a grooved member extending along the holding member, and
a stud member slidably coupled along the grooved member of the holding member.

14. The apparatus as claimed in claim 12, wherein at least one of the slidable member of the pair of slidable member comprises a measuring marking to measure a position of the sliding assembly.

15. The apparatus as claimed in claim 12, wherein at least one of the stud member of the pair of stud member comprises a locking rim coupled to the stud member to lock and unlock the stud member to enable restricting and sliding of the sliding assembly along the channel configuration.

16. The apparatus as claimed in claim 6 further comprising a height adjustable knob configured to the housing member and engaged with at least one platform to adjust the at least one platform in the vertical direction.

17. The apparatus as claimed in claim 6 further comprising a depth adjustable arrangement configured to the housing member, the depth adjustable arrangement having:
a depth adjusting knob, and
a depth adjusting groove, wherein the depth adjusting knob is disposed along the depth adjusting groove and engaged with at least one platform to adjust the depth of the at least one platform in the lateral direction.

18. The apparatus as claimed in claim 6 further comprising:
a plurality of lighting buttons; and
a plurality of colored lights operatively configured with the plurality of lighting buttons, wherein the plurality of lighting buttons disposed along the housing member to enable lightening of the housing member.

19. The apparatus as claimed in claim 6 further comprises a powering arrangement to power the apparatus, the powering arrangement having a powering point and a powering button.

20. A system for photography of an ornament using at least one photography device, the system comprising:
an apparatus having:
a viewing angle configuration taperedly aligned to provide an angled view to the ornament, and
a first sliding assembly slidingly and taperedly aligned along the viewing angle configuration; and
a photography module incorporated in the at least one photography device, wherein the photography module is wirelessly coupled to the apparatus to capture photographs of the ornament,
wherein the first sliding assembly is adapted to receive at least one photography device to taperedly align the at least one photography device along the viewing angle configuration for photography of the ornament via the photography module.
